(19) United States
(12) Patent Application Publication
(10) Pub. No.: US 2006/0111076 A1
(43) Pub. Date: May 25, 2006

(54) Electronic device holder

(76) Inventors: Sean N. Davie, Lawrenceville, GA (US); William C. Phelps III, Lawrenceville, GA (US)

Correspondence Address: MOTOROLA, INC.;LAW DEPARTMENT, 600 NORTH U.S. HIGHWAY 45, AS437, LIBERTYVILLE, IL, 60048, US

(21) Appl. No.: 10/994,442

(22) Filed: Nov. 22, 2004

(51) Int. Cl. H04M 1/00

(52) U.S. Cl. 455/347

(57) ABSTRACT

A holder for an electronic device includes a cradle, or receiving section, for an electronic device, and a coupling section for coupling to an accessory. The receiving section has a bottom and at least three sides, and is capable of accommodating an electronic device like a cellular telephone. The sides project from the bottom at a presentation angle of between 45 and 90 degrees so that the electronic device is easily viewable by a user. The coupling section includes a concave, semi-hemispherical member suitable for coupling to round, convex objects like hands free and speakerphone accessories.

### TECHNICAL FIELD

This invention relates generally accessories for electronic devices, and more specifically to a holder or stand capable of coupling to another device like a vehicular power adaptor, for holding an electronic device like a cellular telephone.

### BACKGROUND ART

Cellular phones, once a luxury few could afford, are now commonplace. It seems today that everyone has a cellular telephone. They talk on these phones at home, at the office, at restaurants and everywhere in between. One of the most popular places for people to use cellular telephones is in the car. People frequently make the most of their drive time by catching up with friends or coworkers on the phone.

Using a phone while driving can pose a safety concern, however. As is taught in every driver's education course, the safest drivers keep two hands on the steering wheel whenever possible. If one uses a hand to hold a telephone to their ear, rather than keeping that hand on the steering wheel, their driving skills may be compromised.

For this reason, many people today elect to use audio accessories for their phones, including “hands free” accessories. For example, many manufacturers make speaker-phone devices that project the incoming audio signal from a cellular phone throughout the car with a loudspeaker. As such, a user may talk on the phone without having to take their hands off the wheel, because the hands free accessory has converted their cellular phone to a “speaker phone”. Frequently, these hands free devices include charging components as well. They may even couple to a cigarette lighter receptacle to charge the battery of the phone while in use.

Most of these hands free accessories couple to the phone via a wire and plug. To use such a device, a user first couples the plug to the phone. The user then places the phone somewhere in the car, generally either the passenger's seat or somewhere in the center console. Unfortunately, there typically is no good place in the car to fixedly store the phone.

The problem with this arrangement is that the loose phone, especially when lying in the passenger's seat, can become a projectile. Any sudden stop, start or turn and Newton's laws of motion take over. Inertia may cause the phone to fly off the seat and hit a door, windshield or other object in the car.

Prior art solutions to this problem include holders that permanently mount to the dashboard of the car. These solutions are inadequate because they require the user to either screw the holder to the car or stick the holder to the car with permanent adhesive. Either of these mounting options is unsatisfactory to the car owner, as they are generally unwilling to damage the car during holder installation.

There is thus a need for an improved holding mechanism for use with other accessories, like hands free devices, that keeps an electronic device, like a cellular telephone, in a fixed position.

### BRIEF DESCRIPTION OF THE DRAWINGS

FIG. 1 illustrates a perspective view of a holder in accordance with the invention.

FIG. 2 illustrates a front view of a holder in accordance with the invention.

FIG. 3 illustrates a side view of a holder in accordance with the invention.

FIG. 4 illustrates a perspective view of a holder in accordance with the invention coupled to a hands free accessory.

FIG. 5 illustrates a front view of a holder in accordance with the invention coupled to a hands free accessory.

FIG. 6 illustrates a side view of a holder in accordance with the invention coupled to a hands free accessory.

### DETAILED DESCRIPTION OF THE INVENTION

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a”, “an,” and “the” includes plural reference, the meaning of “in” includes “in” and “on.”

This invention is a holder or cradle for an electronic device, like a cellular telephone for example. In one embodiment, the holder includes a cradle for accommodating the electronic device. The cradle includes a bottom and at least three sides. The cradle is mounted to one end of a connecting member. A concave coupling section, suitable for coupling to a convex object like a speakerphone accessory or other similar device, is coupled to the other end of the connecting member.

The concave coupling section wraps about the convex object. When the electronic device is inserted into the cradle, a dynamic moment is created. A pivot plate in the concave coupling section opposes the moment, thereby securely coupling the holder to the convex object.

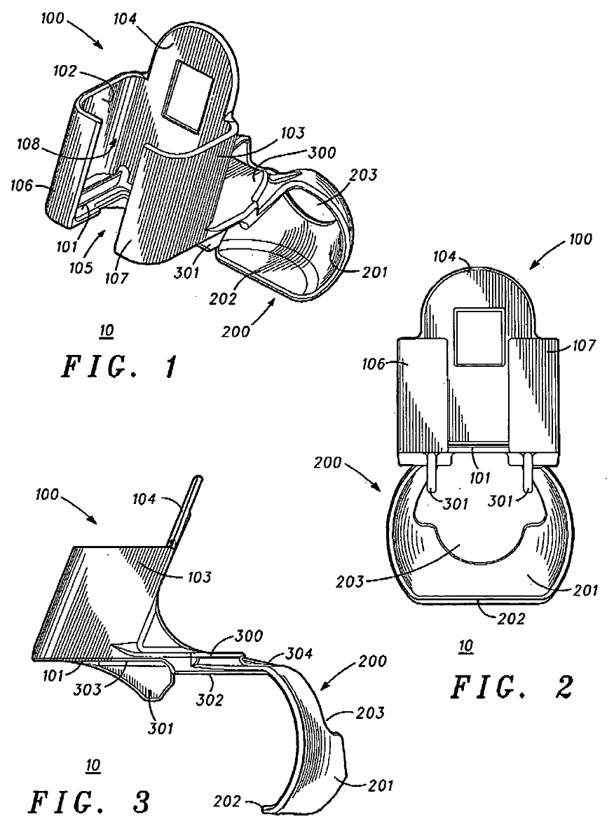

Turning now to FIGS. 1-3, illustrated therein are a perspective view of a holder 10 in accordance with the invention, a front view of the holder and a side view of the holder, respectively. These views will be referred to herein collectively, since they are alternate views of one embodiment of the invention.

The holder includes a receiving section 100, also known as a cradle, and a coupling section 200. The receiving section 100 is for accommodating and securely holding an electronic device, like a cellular telephone, radio, pager, personal digital assistant, media player or other electronic device in place. The holder is preferably made of plastic, like polycarbonate or polycarbonate-ABS, by way of an insert molding process.

The receiving section 100 includes a base member 101, or bottom, for supporting the electronic device and at least three side members 102-104, or sides, for laterally supporting the electronic device. The side members 102-104 project distally from the base member 101 at an angle of between 45 and 90 degrees. This projection angle is set such that the electronic device may easily be seen by the user when inserted into the receiving section 100. The side members 102-104 may be adjustable so that the projection angle may be changed to accommodate the user's viewing angle.

In one embodiment, one of the three side members 104 is longer than the other two 102,103. The extra length provides additional support to the electronic device when the projection angle is set less than 90 degrees.

In one embodiment, the base member 101 includes an aperture 105 disposed therein. Such an aperture 105 is desirable when the electronic device includes a connector that is disposed on the side of the electronic device that contacts the base member 101 when the device is seated in the receiving section 100. In such scenarios, the aperture 105 provides a space through which a connecting cable, like those connected to hands free and speakerphone devices, may pass.

Two of the sides 102,103 optionally have partial side members 106,107 coupled thereto. The partial side members 106,107 form a “partial fourth side”, in that the partial side members 106,107 extend in a generally perpendicular fashion from side members 106,107. The partial side is desirable where the electronic device includes a display, as the display may be viewed by a user through the slot 108 between the partial side members 106,107.

The holder 10 also includes a coupling section 200 for accommodating a round object, like a vehicular power adaptor, hands free accessory or other similar device. A connecting member 300 connects the coupling section 200 with the receiving section 100. In one embodiment, the connecting member 300 includes a first end 303 and a second, distal end 304. The receiving section 100 is connected to the first end 303, while the coupling section 200 is coupled to the second, distal end 304 of the connecting member 300.

The coupling section 200 is concave in shape, in that it includes at least a semi-hemispherical member 201 that is capable of coupling to round objects like speakerphone accessories and other similar devices. The term “semi-hemispherical” is used because the coupling section needn't necessarily be exactly half a sphere. Additionally, it needn't be spherical, but may instead be some alternate concave curvature as applications warrant.

The semi-hemispherical member 201 works in conjunction with a pivot plate 202 and a fulcrum 301 to couple to a device. As is best seen in FIG. 3, the holder 10 has a center of gravity 302. The center of gravity 302 moves slightly when objects are coupled to the receiving section 100 and coupling section 200, but generally stays beneath the connecting member 300. The first end 303 of the connecting member is positioned on one side of the center of gravity 302, while the second end 304 is positioned on a second, opposite side of the center of gravity 302.

When the coupling section 200 is connected to a convex object, like the speaker of a hands free accessory for example, and an electronic device is placed in the receiving section 100, the center of gravity shifts closer to the receiving section 100 than the coupling section 200. This creates a moment that attempts to make the holder 10 rotate counterclockwise (as viewed in FIG. 3). The fulcrum 301 and pivot plate 202 serve to oppose this force, and thereby keep the holder 10 securely coupled to the convex object.

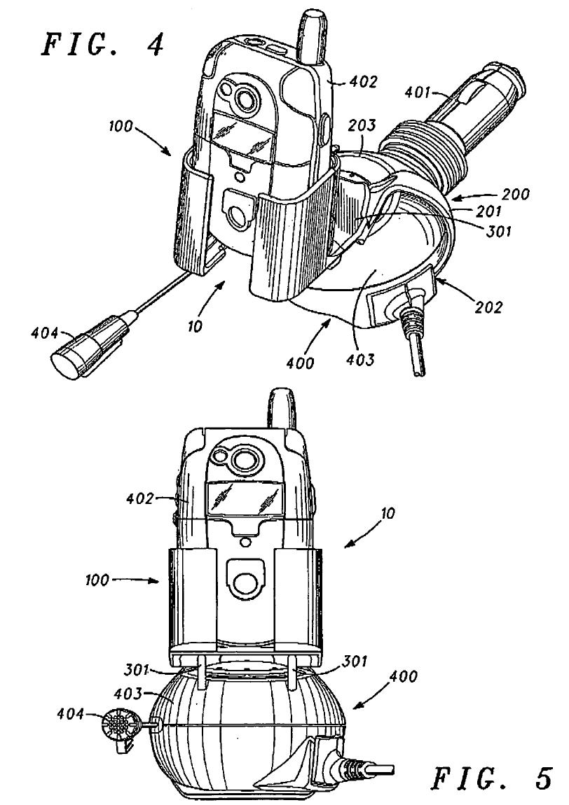

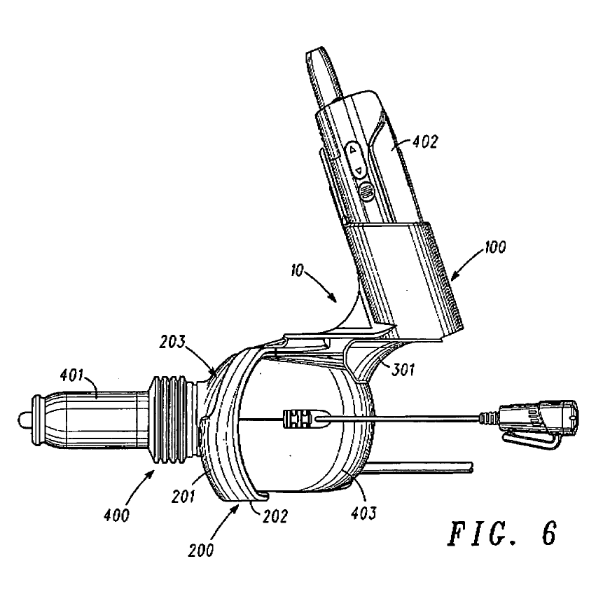

The semi-hemispherical member 201 optionally includes an aperture 203 disposed therein. Where the device to which the holder 10 is coupled is a vehicular power adaptor or other similar device, the power adaptor portion, suitable for coupling to a cigarette lighter connector, may protrude through the aperture 203 in the semi-hemispherical member 201. This will be illustrated in FIGS. 4-6.

Turning now to FIGS. 4-6, illustrated therein are a perspective view of a holder in accordance with the invention coupled to a hands free accessory, a front view thereof and a side view thereof, respectively. While the accessory is a hands free accessory, and while the electronic device is a cellular telephone, it will be clear to those of ordinary skill in the art having the benefit of this disclosure that the invention is not so limited. It could equally receive any number of electronic devices, as well as be coupled to any number of accessories.

The holder 10 has been coupled to a hands free device 400. In this particular embodiment, the hands free device 400 comprises a speaker module 403, an optionally retractable microphone 404 and a cigarette lighter adaptor 401. The speaker module 403 is generally convex in shape, and is somewhat spherical.

The speaker module 403 has been coupled to the coupling section 200, such that the convex speaker module 403 fits within the semi-hemispherical member 201. The cigarette lighter adaptor 401 passes through the aperture 203 in the semi-hemispherical member 201. The pivot plate 202 rests against the bottom of the speaker module 403, while the fulcrum 301 rests on the speaker module 403 approximately half way around the speaker module 403 from the pivot plate 202.

The electronic device 402 is inserted into the receiving section 100, and thereby creates a moment about the speakerphone module 403. The moment is opposed by the pivot plate, thereby securely maintaining the electronic device in place.

This invention includes many advantages over the prior art. In one embodiment, the holder may be used in a vehicle, with a vehicular power adaptor or cigarette lighter adaptor for example. It is easily mounted and secures the electronic device in a readily viewable, accessible location. This is especially true when attached to other devices like hands free accessories.

The invention can attach to other accessories, thereby minimizing the amount of space required in a vehicle for the accessory, electronic device and holder. Apertures in the holder facilitate cable attachment to the electronic device. Additionally, the easily viewable presentation angle may be adjustable. The invention also eliminates the need for screws or permanent adhesives.

While the preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims.

What is claimed is:

1. A holder for an electronic device, comprising:
a. a cradle for accommodating the electronic device, the cradle comprising:
i. a bottom; and
ii. at least three sides;
b. a concave coupling section for connecting to a convex object, the concave coupling section comprising a pivot plate; and
c. a connecting member, the connecting member coupling the cradle and the concave coupling section.

2. The holder of claim 1, wherein the cradle is disposed at a first end of the connecting member, further wherein the concave coupling section is disposed at a second end of the connecting member.

3. The holder of claim 2, wherein the bottom of the cradle comprises at least one aperture disposed therein.

4. The holder of claim 2, wherein the concave coupling section comprises at least one aperture disposed therein.

5. The holder of claim 2, wherein the at least three sides extend distally from the bottom at an angle of between 45 and 90 degrees.

6. The holder of claim 5, wherein one of the at least three side members is longer than the other two side members.

7. The holder of claim 5, wherein two of the side members are each coupled to at least one partial side member.

8. A holder for an electronic device, comprising:
a. a receiving section for accommodating the electronic device, the receiving section comprising:
i. a base member for supporting the electronic device; and
ii. at least three side members for supporting the electronic device;
b. a coupling section for accommodating a vehicular adaptor, the coupling section comprising:
i. at least a semi-hemispherical member; and
ii. a pivot plate;
c. a connecting member, the connecting member coupling the receiving section and the coupling section, wherein the receiving section is disposed at a first end of the connecting member, further wherein the coupling section is disposed at a second, distal end of the connecting member.

9. The holder of claim 8, wherein the holder has a center of gravity, wherein the first end of the connecting member is positioned on a first side of the center of gravity, further wherein the second end of the connecting member is positioned on a second side of the center of gravity, wherein the first side is opposite the second side.

10. The holder of claim 8, wherein the base member of the receiving section comprises at least one aperture disposed therein.

11. The holder of claim 8, wherein the coupling section comprises at least one aperture disposed within the at least a semi-hemispherical member.

12. The holder of claim 8, wherein the at least three side members of the receiving section extend distally from the base member at a presentation angle of between 45 and 90 degrees.

13. The holder of claim 12, wherein the presentation angle is adjustable.

14. The holder of claim 12, wherein one of the at least three side members is longer than the other two side members.

15. The holder of claim 12, wherein two of the side members are each coupled to at least one partial side member.

16. The holder of claim 8, further comprising a fulcrum extending from the connecting member.
